(19) United States
(12) Patent Application Publication
(10) Pub. No.: US 2026/0147428 A1
(43) Pub. Date: May 28, 2026

(54) Touch Controller and Method for use in Touch Controller

(71) Applicant: NOVATEK Microelectronics Corp., Hsin-Chu (TW)

(72) Inventor: Yen-Cheng Cheng, Hsinchu City (TW)

(73) Assignee: NOVATEK Microelectronics Corp., Hsin-Chu (TW)

(21) Appl. No.: 18/963,400

(22) Filed: Nov. 27, 2024

(51) Int. Cl. G06F 3/041

(52) U.S. Cl. CPC G06F 3/041661; G06F 2203/04104

(57) ABSTRACT

A touch controller is used to control a touch panel. The touch panel has an array of sensor cells divided in to N columns, each column has M regions, M regions are grouped into P zones. The touch controller has a switch circuit and a sensing circuit. In a coarse scan period, the switch circuit shorts the sensor cells in each zone of each column, and the sensing circuits scans P×N zones of the N columns to generate P×N zone signals. In M fine scan periods, the switch circuit decouples the sensor cells in a triggered zone of the P×N zones, and the sensing circuit scans a region of the triggered zone without scanning untriggered zones of the P×N zones to generated cell signals.

### BACKGROUND OF THE INVENTION

### 1. Field of the Invention

The invention is related to touch sensing techniques, especially related to a touch controller and a method for use in the touch controller for controlling a touch panel.

### 2. Description of the Prior Art

The evolving technology has led to the integration of touch panels in various electronic devices, enhancing their user interface. However, the larger the touch panel, the greater control effort is needed for the associated electronic components, leading to increased power consumption.

For example, a touch panel is usually made up of an array of sensor cells for detecting a user's touch. The touch panel scans all sensor cells to determine which of the sensor cells detects a touch event. Therefore, even if the touch event merely affect a small portion of sensor cells, the touch panel will not complete the detection until all sensor cells are scanned, resulting in unnecessary power consumption.

Therefore, there is a need for a touch controller and a method for use in the touch controller to reduce power wastage by the touch panel during touch events sensing.

### SUMMARY OF THE INVENTION

According to one embodiment of the invention, a touch controller is used to control a touch panel. The touch panel includes an array of sensor cells divided into N columns, each column comprising M regions, the M regions in each column being grouped into P zones, N and M being integers exceeding 1, P being a positive integer less than M+1. The touch controller includes a switch circuit coupled to the touch panel and a sensing circuit coupled to the switch circuit. In a coarse scan period, the switch circuit shorts the sensor cells in each zone of each column, and the sensing circuit scans P×N zones of the N columns to generate P×N zone signals. In M fine scan periods, the switch circuit decouples the sensor cells in a triggered zone of the P×N zones, and the sensing circuit scans a region of the triggered zone without scanning untriggered zones of the P×N zones to generate cell signals of the sensor cells in the triggered zone.

According to another embodiment of the invention, a method is used in a touch controller to control a touch panel. The touch panel includes an array of sensor cells divided into N columns, each column comprising M regions, the M regions in each column being grouped into P zones, N and M being integers exceeding 1, P being a positive integer less than M+1. The touch controller includes a switch circuit and a sensing circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic device according to an embodiment of the invention.

FIGS. 2A and 2B are schematic diagrams illustrating configurations of a touch panel.

FIG. 3 is a schematic diagram illustrating a control means for the touch panel in response to a touch event.

FIG. 4 is a schematic diagram illustrating configuration of a touch panel.

FIG. 5 is a schematic diagram illustrating a control means for the touch panel in response to a touch event.

FIG. 6 is a schematic diagram illustrating a control means for the touch panel in response to a touch event.

FIG. 7A and FIG. 7B are schematic diagrams illustrating a control means for the touch panel in response to a touch event.

FIG. 8A, FIG. 8B and FIG. 8C are schematic diagrams illustrating a control means for the touch panel in response to a touch event.

FIG. 9A and FIG. 9B are schematic diagrams illustrating a control means for the touch panel in response to a touch event.

FIG. 10 is a flow chart describing a method for use in a touch controller according to an embodiment of the invention.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

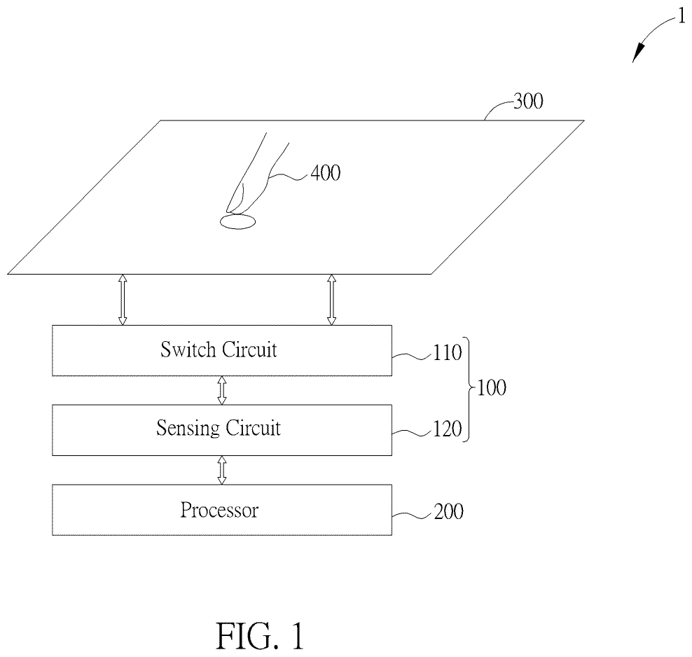

FIG. 1 depicts an electronic device 1 having a touch controller 100, a touch panel 300 and a processor 200. The electronic device 1 may be, but is not limited to, a display device. The touch panel 300 may be an in-cell touch panel and may include an array of sensor cells for detecting a touch event 400. The touch event 400 may correspond to a finger touch on the touch panel 300, or a brush stroke by a stylus on the touch panel 300. The touch controller 100 may include a switch circuit 110 and a sensing circuit 120 coupled to the switch circuit 110. The switch circuit 110 may be coupled to the touch panel 300. The switch circuit 110 may include switches, logical gates and/or multiplexers to manage connections of the sensor cells in the touch panel 300. During the touch detection, the switch circuit 110 may sequentially select sets of sensor cells of the touch panel 300, coupling the selected sets of sensor cells to the sensing circuit 120. The sensing circuit 120 may include analog front ends (AFEs) to scan the selected sets of sensor cells of the touch panel 300 to detect the touch event 400. The processor 200 may be coupled to the touch controller 100 for processing signals detected by the sensing circuit 120 in response to the touch event 400. In some embodiments, the processor 200 may be disposed in the touch controller 100.

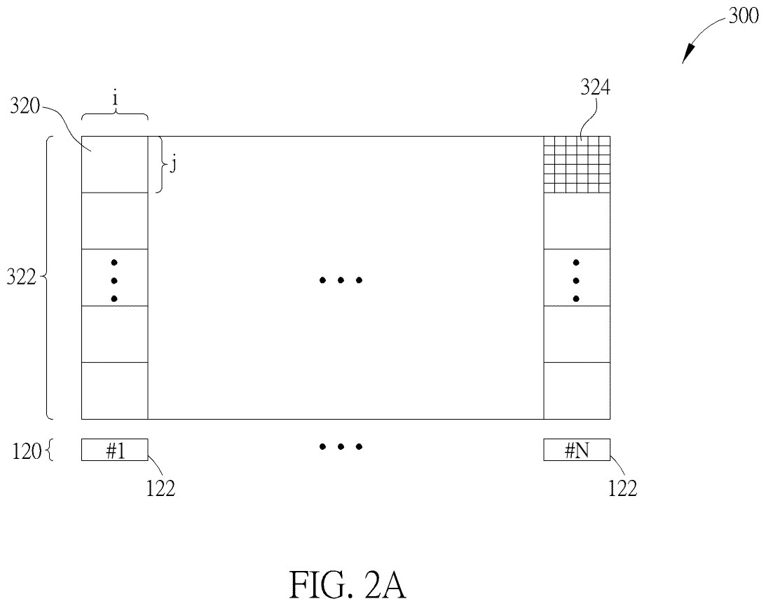

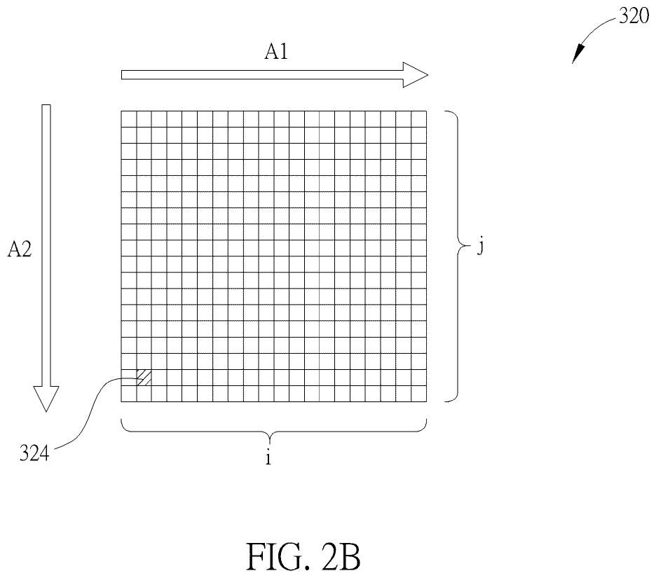

FIGS. 2A and 2B depict arrangements of the touch panel 300. The array of sensor cells 324 on the touch panel 300 may be divided into N columns 322, and the sensing circuit 120 may include N touch integrated circuits (IC) 122, N being an integer exceeding 1. Each column 322 may be controlled by a corresponding touch IC 122. Each column 322 may include M regions 320 of sensor cells 324 M being an integer exceeding 1. Each region 320 may be formed by i×j sensor cells 324, i and j being integers exceeding 1.

Each touch IC 122 may include multiple AFEs. In some embodiments, if the i×j sensor cells 324 are shorted (merged) together, one of the AFEs may simultaneously scan the i×j sensor cells 324 to identify a touch event associated with the region 320. In other words, the sensing circuit 120 may detect a touch event on the touch panel 300 based on the regions 320. In other embodiments, if the i×j sensor cells 324 are decoupled from each other, each AFE may scan an individual sensor cell 324 to identify a touch event associated with each sensor cell 324. For example, if i=16, j=16, and the number of the AFEs in the touch IC 122 is 64, the 64 AFEs may scan the 16×16 sensor cell 324 in 4 passes, generating 64 results per pass, thus producing 256 results. The 256 results are used to identify one or more touch events associated with one or more sensor cells 324.

The sensing circuit 120 may perform two distinct scan operations: a coarse scan and a fine scan. The M regions 320 in each column may be grouped into P zones, P being a positive integer less than M+1. In some embodiments, P=1, and the M regions 320 in each column are grouped into 1 zone, leading to rapid detection of a touch event. In other embodiments, P=M, and each region 320 in each column forms an individual zone, resulting in more precise detection of a touch event. In other embodiments, 1<P<M, and the M regions 320 in each column are divided into multiple zones, providing a balance between speed and accuracy in touch detection. During the coarse scan, the processor 200 may determine whether a touch event has taken place in a particular zone. If a touch event is detected, the AFEs may conduct a fine scan accordingly. During the fine scan, the AFEs may scan each sensor cell 324 in the particular zone to determine the exact position of the touch event.

To determine the exact position of the touch event 400 on the touch panel 300, the AFEs may scan the sensor cells 324 in the region 320 either column by column (as indicated by the direction A1) or row by row (as indicated by the direction A2). However, the sensor cells 324 in a region 320 may also be scanned in any other preferred sequence to achieve the optimal efficiency.

The process of detecting the touch event 400 may be described as follows. In a coarse scan period, the switch circuit 110 may short sensor cells 324 in each zone of each column 322, and the sensing circuit 120 may scan the P×N zones of the N columns to generate P×N zone signals; and in M fine scan periods subsequent to the coarse scan period, the switch circuit 110 may decouple the sensor cells 324 in a triggered zone of the P×N zones, and the sensing circuit 120 may scan the region(s) 320 of the triggered zone without scanning untriggered zones of the P×N zones to generate cell signals of the sensor cells 324 in the triggered zone.

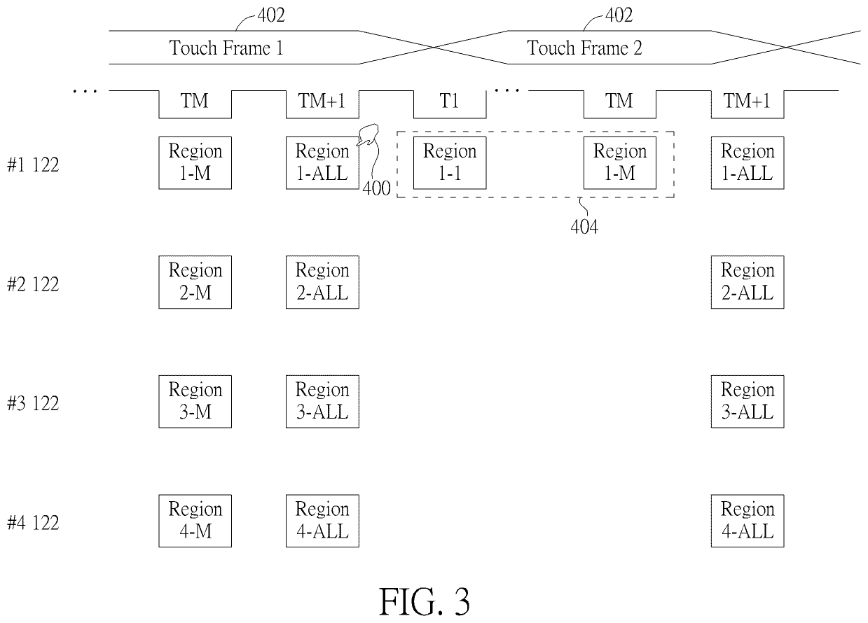

FIG. 3 depicts an example where the touch panel 300 is divided into 4 columns 322 (i.e., N=4), and the M regions 320 in each column 322 are grouped into one zone (i.e., P=1). In this scenario, a touch frame period 402 may include M fine scan periods and one coarse scan period. The M fine scan periods may be defined by the M regions 320 on the column 322 (i.e., T1 through TM), such that an mth region 320 of the M regions 320 on a column 322 may be finely scanned at a corresponding mth period during the M fine scan periods. The coarse scan period may be placed at the last period (TM+1) of the touch frame periods 402. The blocks marked with Column-Region numerals are placed under corresponding periods of the touch frame periods 402 to represent an mth region 320 in an nth column 322 being scanned during an mth period. Further, m is an integer between 1 and M, and n is an integer between 1 and N.

During the coarse scan period of a first touch frame period 402 (e.g., TM+1 of Touch Frame 1), the coarse scan is performed on all regions 320 of the four columns 322 to detect the touch event 400. The switch circuit 110 may short the sensor cells 324 in each column 322, and the sensing circuit 120 may scan the four columns 322 to generate four zone signals. In the coarse scan, each touch IC 122 may have one AFE scanning a column 322, leading to a total of 4 AFEs, each scanning one of the 4 columns 322 respectively. Each AFE may generate a zone signal to indicate whether a corresponding column 322 has been touched. Based on the zone signals, the processor 200 may identify a triggered zone 404 associated with the touch event 400. In this embodiment, the touch event 400 is happened on the Region 1-ALL, the triggered zone 404 is identified as Column 1 of the touch panel 300. The processor 200 may further identify one or more untriggered zones according to the four zone signals. In this embodiment, the processor may determine that Regions 2-ALL to 4-ALL are the untriggered zones accordingly.

During the M fine scan periods of a second touch frame period 402 (e.g., T1 through TM of Touch Frame 2), the fine scan is performed on the triggered zone 1, one region at a period, so as to determine an exact position of the touch event 400 on the touch panel 300. The switch circuit 110 may decouple the sensor cells 324 in the triggered zone 404, and the sensing circuit 120 may respectively scan Region 1-1 through Region 1-M of the triggered zone 404 in the corresponding periods T1 through TM to generate cell signals for sensor cells 324 in each region 320 of Column 1. In an m-th period of the M fine scan periods, the sensing circuit 120 may scan Region 1-m of the triggered zone 404 to generate the cell signals of the sensor cells 324 in Region 1-m of the triggered zone 404, m being an integer ranging between 1 and M. In the fine scan, each touch IC 122 may have 64 AFEs scanning regions in a column 322. For example, if m=1, in the first period of the M fine scan periods, the 64 AFEs in the first touch IC 122 may scan the 256 sensor cells 324 in Region 1-1 of the triggered zone 404 in 4 passes to generate 256 cell signals of the 256 sensor cells 324 in Region 1-1 of the triggered zone 404, each cell signal indicating whether a corresponding sensor cell 324 has been touched. Based on the cell signals, the processor 200 may then identify an exact position on the touch panel 300 that the touch event 400 is contacted with. During the M fine scan periods, an untriggered zone on the touch panel 300 may refer to Column 2 through Column 4, and the sensing circuit 120 would not scan the untriggered zone, thereby saving power.

In other embodiments, the coarse scan period may also be placed at a first period of the touch frame period 402, such that the coarse scan period and the M fine scan periods would be placed in a same touch frame period 402. However, the order of the coarse scan period and the M fine scan periods is not meant to limit the present invention.

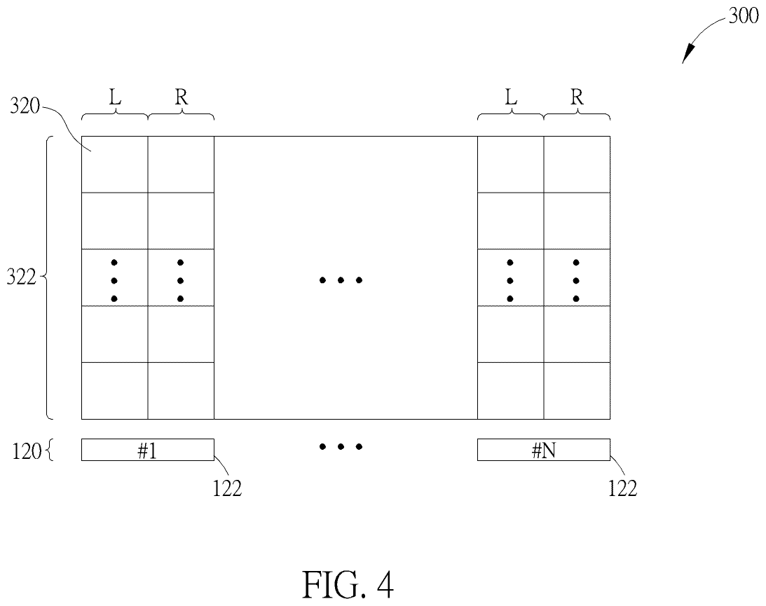

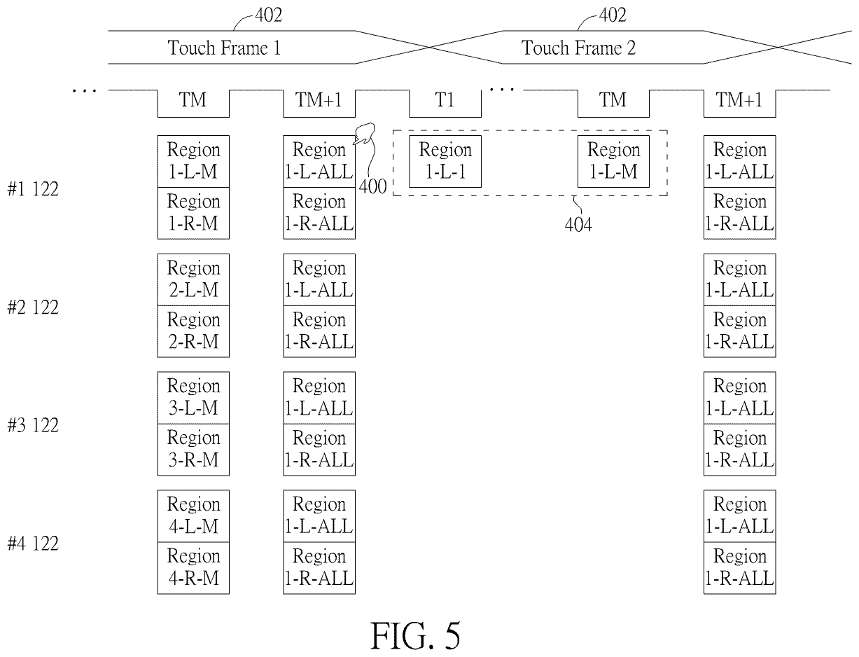

In some embodiments, one touch IC 122 of the sensing circuit 120 may manage more than one column 322 of regions 320. FIG. 4 depicts an example where each touch IC 122 manages two columns 322 of M regions 320. FIG. 5 depicts an alternate example of FIG. 3 where the touch panel 300 is divided into 8 columns, each column 322 of the regions 320 are grouped into one zone (i.e., P=1), and each touch IC 122 is in charge of a left column (L) and a right column (R).

In FIG. 5, each touch IC 122 may have 2 AFEs scanning a left column (L) and a right column (R) in the coarse scan, leading to a total of 8 AFEs, each scanning one of the 8 columns 322 respectively. For example, the 8 AFEs in the sensing circuit 120 may respectively scan the 8 columns 322 (including 4 left columns and 4 right columns), each generating a zone signal to indicate whether a corresponding column 322 has been touched. Similarly, when the zone signals from the coarse scan period of the first touch frame period 402(e.g., TM+1 of Touch Frame 1) has determined the touch event 400 to be associated with only Column L of Column 1, the triggered zone 404 would be set as Region 1-L-1 through Region 1-L-M of Column 1, and the untriggered zones would be set as all regions 320 of Column R of Column 1 and Column L and Column R of Column 2 through Column 4. That is, only the triggered zone 404 would be scanned during the M fine scan periods of the second touch frame period (e.g., touch frame 2), and the untriggered zones would not be scanned to save power. In the fine scan, each touch IC 122 may have 32 AFEs scanning regions in a left column (L) and 32 AFEs scanning regions in a right column (R). For example, the 32 AFEs in the first touch IC 122 may, during each of the M fine scan periods, respectively scan the 256 sensor cells 324 in each region 320 of left column (L) in 4 passes to generate 256 cell signals, each cell signal indicating whether a corresponding sensor cell 324 has been touched. Similarly, the 32 AFEs in the first touch IC 122 may, during each of the M fine scan periods, respectively scan the 256 sensor cells 324 in each region 320 of right column (R) in 4 passes to generate 256 cell signals, each cell signal indicating whether a corresponding sensor cell 324 has been touched. Based on the resulted M×256 cell signals, the processor 200 may then identify an exact position on the touch panel 300 that the touch event 400 is contacted with.

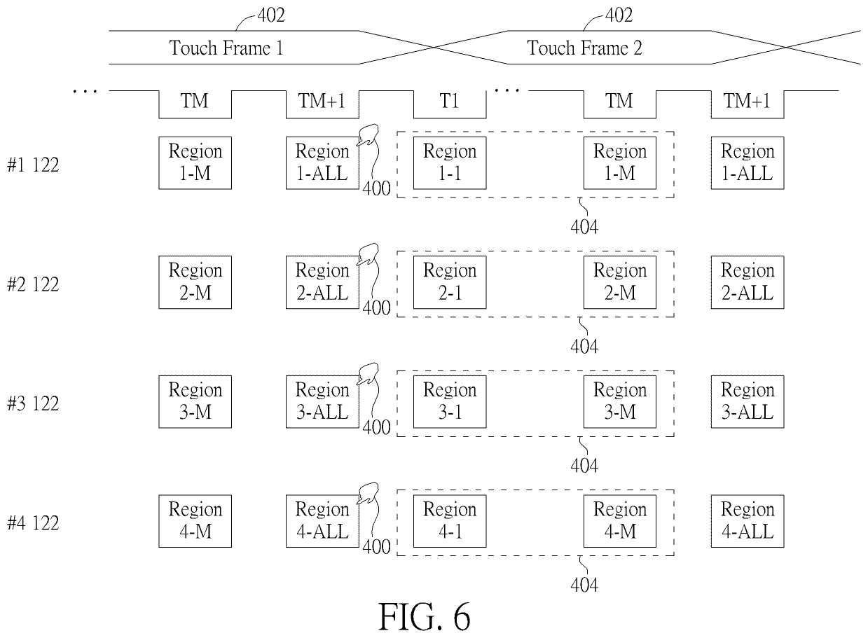

In some embodiments, the touch event 400 may occur in more than one column 322 on the touch panel 300. FIG. 6 depicts an alternate example of FIG. 3 when each column 322 of the regions 320 are grouped into one zone (i.e., P=1), and Column 1 through Column 4 are all associated with the touch event 400.

In FIG. 6, for example, the 4 AFEs in the sensing circuit 120 may respectively scan the 4 columns 322, each generating a zone signal to indicate whether a corresponding column 322 has been touched. Similarly, the processor 200 may identify the zone signals from the coarse scan period of the first touch frame period 402 (e.g., TM+1 of Touch Frame 1) and determines that Column 1 through Column 4 should all be set as triggered zones 404. Therefore, Column 1 through Column 4 would be concurrently scanned by the sensing circuit 120 during the M fine scan periods in the second touch frame period 402 (e.g., T1 through TM of Touch Frame 2). In an m-th period of the M fine scan periods, the sensing circuit 120 may scan Region 1-m of the triggered zone 404 to generate the cell signals of the sensor cells 324 in Region 1-m of the triggered zones 404, m being an integer ranging between 1 and M. For example, if m=1, in the first period of the M fine scan periods, the 64 AFEs of each touch IC 122 in the sensing circuit 120 may, during each of the M fine scan periods, respectfully scan the 256 sensor cells 324 in each region 320 in 4 passes to generate 256 cell signals, each cell signal indicating whether a corresponding sensor cell 324 has been touched. Based on the resulted 4×M×256 cell signals, the processor 200 may then identify exact positions on the touch panel 300 that the touch events 400 are contacted with. Likewise, if the touch panel 300 contains other columns 322 aside from Column 1 through Column 4 that are determined to be untriggered zones, then the untriggered zones would not be scanned during the M fine scan periods to save power.

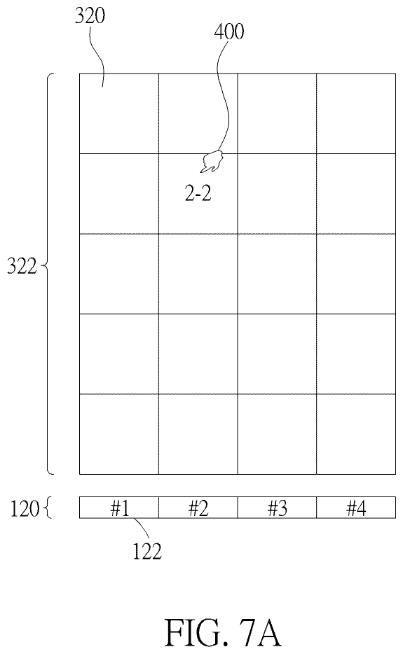

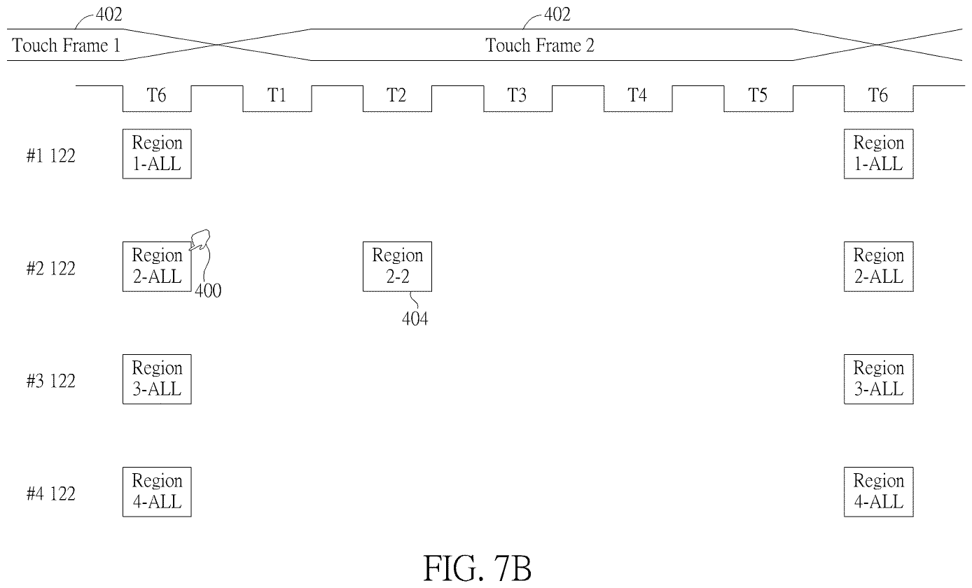

FIG. 7A depicts an example where the touch panel 300 is divided into 4 columns (i.e., N=4), each regions 320 in each column 322 is grouped into one zone (i.e., P=M), and each column 322 has five regions 320 (i.e., M=5). In the coarse scan period, the switch circuit 110 may short the sensor cells 324 in each region 320 of each column 322, and the sensing circuit 120 may scan M×N regions 320 of the N columns to generate M×N zone signals, and in the M fine scan periods, the switch circuit 110 may decouple the sensor cells 324 in a triggered zone of the M×N regions 320 without scanning untriggered zones of the M×N regions 320 to generate the cell signals of the sensor cells in the triggered zone. In some embodiments, in the coarse scan, M×N AFEs of the sensing circuit 120 may simultaneously scan the M×N regions 320 of the N columns to generate M×N zone signals. For example, if N=4, M=5, in the coarse scan period, the switch circuit 110 may short the sensor cells 324 in each region 320 of each column 322, and 20(=5×4) AFEs of the sensing circuit 120 may scan 20 regions 320 of the N columns to generate 20 zone signals, and in the 5 fine scan periods, the switch circuit 110 may decouple the sensor cells 324 in a triggered zone of the 20 regions 320 without scanning untriggered zones of the 20 regions 320 to generate the cell signals of the sensor cells in the triggered zone

FIG. 7B describes how scanning during touch frame periods 402 are configured based on arrangements of FIG. 7A. In this scenario, a touch frame period 402 may include 5 fine scan periods and one coarse scan period, and the touch event 400 represents a finger touch on a second region of Column 2 (hereinafter, Region 2-2). The 5 fine scan periods may be defined by the five regions 320 on the columns 322 (i.e., T1 through T5). The coarse scan period may be placed at the last period (i.e., T6) of the touch frame periods 402.

During the coarse scan period of a first touch frame period 402 (e.g., T6 of touch frame 1), the coarse scan is performed on all regions 320 of the four columns 322 to detect the touch event 400. For example, the switch circuit 110 may short the sensor cells 324 in each region 320, and the 4 AFEs in the sensing circuit 120 may respectively scan the 5×4=20 regions 320 of the four columns 322 to generate 20 zone signals. Based on the 20 zone signals, the processor 200 may identify Region 2-2 as the triggered zone 404 associated with the touch event 400. The processor 200 may further identify one or more untriggered zones according to the four zone signals. In the embodiment, the processor may determine that Regions 1-1 to 1-5, 2-1, 2-3 to 2-5, 3-1 to 3-5, and 4-1 to 4-5 are the untriggered zones.

The triggered zone 404 may be located in an m-th region of an n-th column of the N columns, n being an integer ranging between 1 and N, m being an integer ranging between 1 and M. Subsequently, in an m-th period of the M fine scan periods, the sensing circuit 120 may scan Region n-m of the triggered zone 404 to generate the cell signals of the sensor cells 324 in Region n-m of the triggered zone 404. During the 5 fine scan periods of a second touch frame period 402 (e.g., T1 through T5 of Touch Frame 2), the fine scan is performed on the triggered zone 2-2 during a corresponding period T2, so as to determine an exact position of the touch event 400 on Region 2-2. For example, if n=2 and m=2, in the second period T2 of the 5 fine scan periods, the switch circuit 110 may decouple the sensor cells 324 in the triggered zone 404, the 64 AFEs in the sensing circuit 120 may respectively scan the 256 sensor cells 324 in the triggered zone 202 in 4 passes to generate 256 cell signals of the 256 sensor cells 324 in Region 2-2, each cell signal indicating whether a sensor cell 324 has been touched, and the processor 200 may identify a triggered cell corresponding to the sensor cell 324 being touched according to the cell signals. During the 5 fine scan periods, an untriggered zone on the touch panel 300 may refer to all regions 320 except Region 2-2, and the sensing circuit 120 would not scan the untriggered zone to save power.

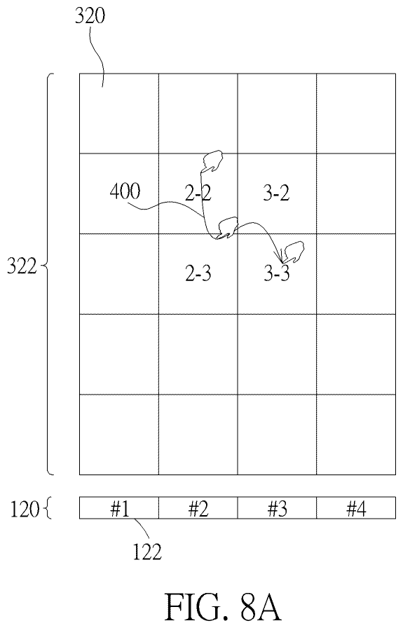

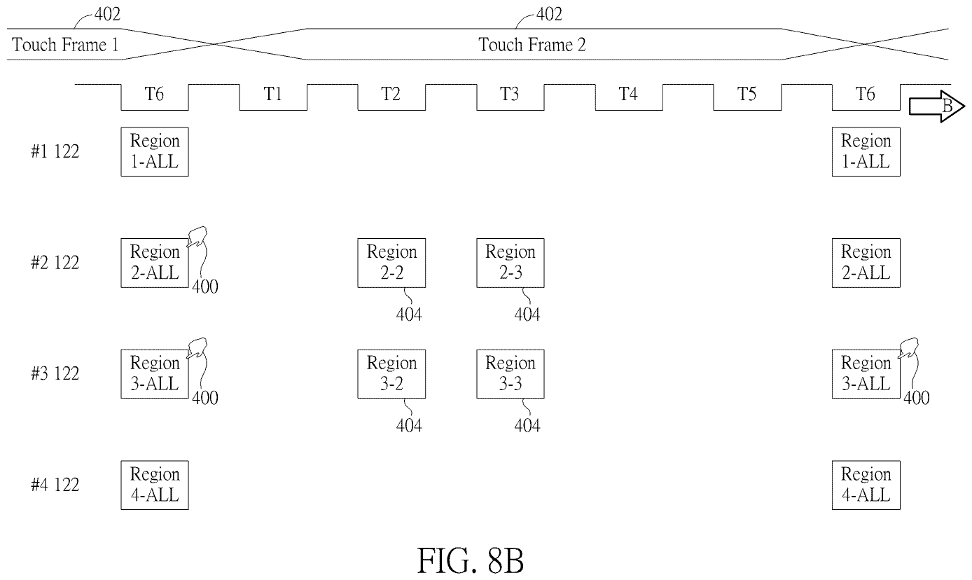

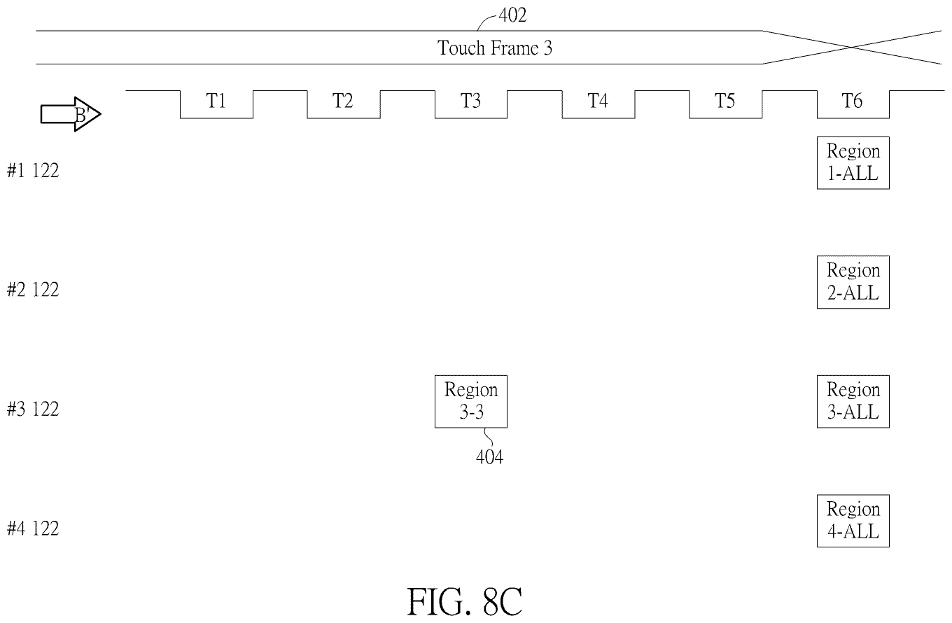

FIG. 8A depicts an alternative example of FIG. 7A when the touch event 400 involves a sequence of finger movements on the touch panel 300 traversing through Region 2-2, Region 2-3,Region 3-2 and Region 3-3. FIGS. 8B and 8C show schematic diagrams of scanning the touch panel 300 in Touch Frames 1 to 3, based on the circuit arrangements in FIG. 8A. Touch Frame 3 from FIG. 8C follows Touch Frame 2 from FIG. 8B in the sequence of time as depicted from B to B′.

As the finger moves across the touch panel 300, touching one or more regions, the processor 200 may identify one or more triggered zones 404 from the 20 regions 320 on the touch panel 300 during a coarse scan. During the coarse scan period of the first touch frame period 402 (e.g., T6 of Touch Frame 1), the processor 200 may take the 20 zone signals from the 20 regions 320 to identify Region 2-2, Region 2-3, Region 3-2 and Region 3-3 as the triggered zones 404 and Regions 1-1 to 1-5, 2-1, 2-4 to 2-5, 3-1, 3-4 to 3-5, and 4-1 to 4-5 as the untriggered zones.

If multiple triggered zones 404 are identified from the 20 regions 320, in a fine scan subsequent to the coarse scan, the switch circuit 110 may decouple the sensor cells 324 in the multiple triggered zones 404, and the sensing circuit 120 may scan the multiple triggered zones 404 to generate the cell signals of the sensor cells 324 in the multiple triggered zones 404. During the 5 fine scan periods of the second touch frame period 402 (e.g., T1 through T5 of Touch Frame 2), the fine scan is performed on the triggered zone 2-2 and Region 3-2 during a corresponding period T2 and the triggered zone 2-3 and Region 3-3 during a corresponding period T3 respectively. Therefore, the exact moving route of the touch event 400 on the triggered zones 404 detected during the first and second touch frame periods 402 may be determined. The sensing circuit 120 would not scan the untriggered zones to save power.

In some embodiments, the multiple triggered zones 404 may be located in different regions 320 of a single column 322. That is, a first triggered zone 404 and a second triggered zone 404 may be respectively an (m1)-th region 320 and an (m2)-th region 320 of a column 322 of the N columns 322, m1 and m2 being different integers ranging between 1 and M. In an (m1)-th fine scan period of the M fine scan periods, the switch circuit 110 decouples the sensor cells 324 in the (m1)-th region 320 of the column 322 of the N columns 322, and the sensing circuit 120 scans the (m1)-th region 320 of the column 322 of the N columns 322 without scanning the untriggered zones of the M×N regions 320 to generate the cell signals of the sensor cells 324 in the (m1)-th region 320 of the column 322 of the N columns 322. In an (m2)-th fine scan period of the M fine scan periods, the switch circuit 110 decouples the sensor cells 324 in the (m2)-th region 320 of the column 322 of the N columns 322, and the sensing circuit 120 scans the (m2)-th region 320 of the column 322 of the N columns 322 without scanning the untriggered zones of the M×N regions 320 to generate the cell signals of the sensor cells 324 in the (m2)-th region 320 of the column 322 of the N columns 322. Referring to FIG. 8B, if N=4, M=5, m1=2, m2=3, a first triggered zone 404 and a second triggered zone 404 may be respectively Region 2-2 and Region 2-3 of the second column 322 of the 4 columns 322. In the fine scan period T2 of the 5 fine scan periods, the switch circuit 110 may decouple the sensor cells 324 in Region 2-2 of the 2nd column of the 4 columns 322, and the sensing circuit 120 may scans Region 2-2 without scanning the untriggered zones to generate the cell signals of the sensor cells 324 in Region 2-2. In the fine scan period T3 of the 5 fine scan periods, the switch circuit 110 may decouple the sensor cells 324 in Region 2-3 of the 2nd column of the 4 columns 322, and the sensing circuit 120 may scan Region 2-3 without scanning the untriggered zones to generate the cell signals of the sensor cells 324 in Region 2-3.

In some embodiments, the multiple triggered zones 404 may be located in different regions 320 of different columns 322. That is, a first triggered zone 404 is an (m1)-th region 320 of an (n1)-th column of the N columns 322, and a second triggered zone 404 is an (m2)-th region 320 of an (n2)-th column of the N columns 322, m1 and m2 being different integers ranging between 1 and M, n1 and n2 being different integers ranging between 1 and N. In an (m1)-th fine scan period of the M fine scan periods, the switch circuit 110 decouples the sensor cells 324 in the (m1)-th region 320 of the (n1)-th column of the N columns 322, and the sensing circuit 120 scans the (m1)-th region 320 of the (n1)-th column of the N columns 322 without scanning the untriggered zones of the M×N regions 320 to generate the cell signals of the sensor cells 324 in the (m1)-th region 320 of the (n1)-th column of the N columns 322. In an (m2)-th fine scan period of the M fine scan periods, the switch circuit 110 decouples the sensor cells 324 in the (m2)-th region 320 of the (n2)-th column of the N columns 322, and the sensing circuit 120 scans the (m2)-th region 320 of the (n2)-th column of the N columns 322 without scanning the untriggered zones of the M×N regions 320 to generate the cell signals of the sensor cells 324 in the (m2)-th region 320 of the (n2)-th column of the N columns 322. Referring to FIG. 8B, if N=4, M=5, n1=2, n2=3, m1=2, m2=3, the first triggered zone 404 may be Region 2-2 of the 2nd column 322 of the 4 columns 322, and the second triggered zone 404 may be Region 3-3 of the 3rd column 322 of the 4 columns 322. In the fine scan period T2 of the 5 fine scan periods, the switch circuit 110 may decouple the sensor cells 324 in Region 2-2 of the 2nd column of the 4 columns 322, and the sensing circuit 120 may scan Region 2-2 of the 2nd column of the 4 columns 322 without scanning the untriggered zones to generate the cell signals of the sensor cells 324 in Region 2-2 of the 2nd column of the 4 columns 322. In the fine scan period T3 of the 5 fine scan periods, the switch circuit 110 may decouple the sensor cells 324 in Region 3-3 of the 3rd column of the 4 columns 322, and the sensing circuit 120 may scan Region 3-3 of the 3rd column of the 4 columns 322 without scanning the untriggered zones to generate the cell signals of the sensor cells 324 in Region 3-3 of the 3rd column of the 4 columns 322.

In some embodiments, the multiple triggered zones 404 may be located in corresponding regions 320 of different columns 322. That is, a first triggered zone 404 is an (m1)-th region 320 of an (n1)-th column of the N columns 322, and a second triggered zone 404 is an (m1)-th region 320 of an (n2)-th column of the N columns 322, m1 being an integer ranging between 1 and M, n1 and n2 being different integers ranging between 1 and N. In an (m1)-th fine scan period of the M fine scan periods, the switch circuit 110 decouples the sensor cells 324 in the (m1)-th region 320 of the (n1)-th column of the N columns 322 and the sensor cells 324 in the (m1)-th region 320 of the (n2)-th column of the N columns 322, and the sensing circuit 120 scans the (m1)-th region 320 of the (n1)-th column of the N columns 322 and the (m1)-th region 320 of the (n2)-th column of the N columns 322 without scanning the untriggered zones of the M×N regions 320 to generate the cell signals of the sensor cells 324 in the (m1)-th region 320 of the (n1)-th column of the N columns 322 and the cell signals of the sensor cells 324 in the (m1)-th region 320 of the (n2)-th column of the N columns 322. Referring to FIG. 8B, if N=4, M=5, n1=2, n2=3, m1=2, the first triggered zone 404 may be Region 2-2 of the 2nd column 322 of the 4 columns 322, and the second triggered zone 404 may be Region 3-2 of the 3rd column 322 of the 4 columns 322. In the fine scan period T2 of the 5 fine scan periods, the switch circuit 110 may decouple the sensor cells 324 in Region 2-2 and Region 3-2, and the sensing circuit 120 may scan Region 2-2 and Region 3-2 without scanning the untriggered zones to generate the cell signals of the sensor cells 324 in Region 2-2 and Region 3-2.

During the coarse scan period of the second touch frame period 402 (e.g., T6 of Touch Frame 2), the processor 200 may further take a further 20 zone signals from the 20 regions 320 and discover the touch event 400 to include the finger movement ending on Region 3-3. Therefore, the processor 200 may identify Region 3-3 to be a further triggered zone 404.

During the 5 fine scan periods of the third touch frame period 402 (e.g., T1 through T5 of Touch Frame 3), the fine scan is performed on the triggered Region 3-3 during a corresponding period T3. Therefore, the exact position where the finger movement ends on the Region 3-3 may be determined. Similarly, a further untriggered zone on the touch panel 300 during Touch Frame 3 may refer to all regions 320 except Region 3-3, and the sensing circuit 120 would not scan the untriggered zone to save power.

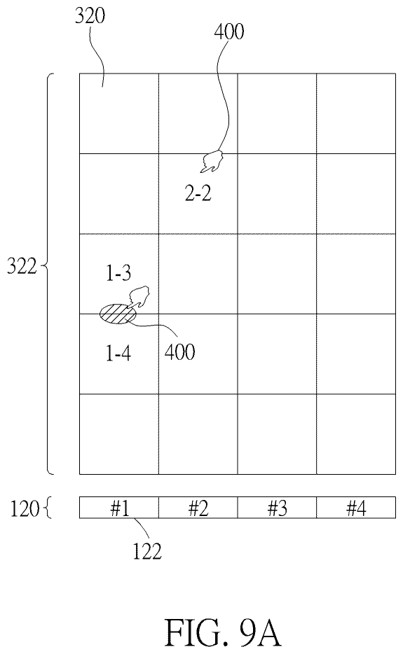

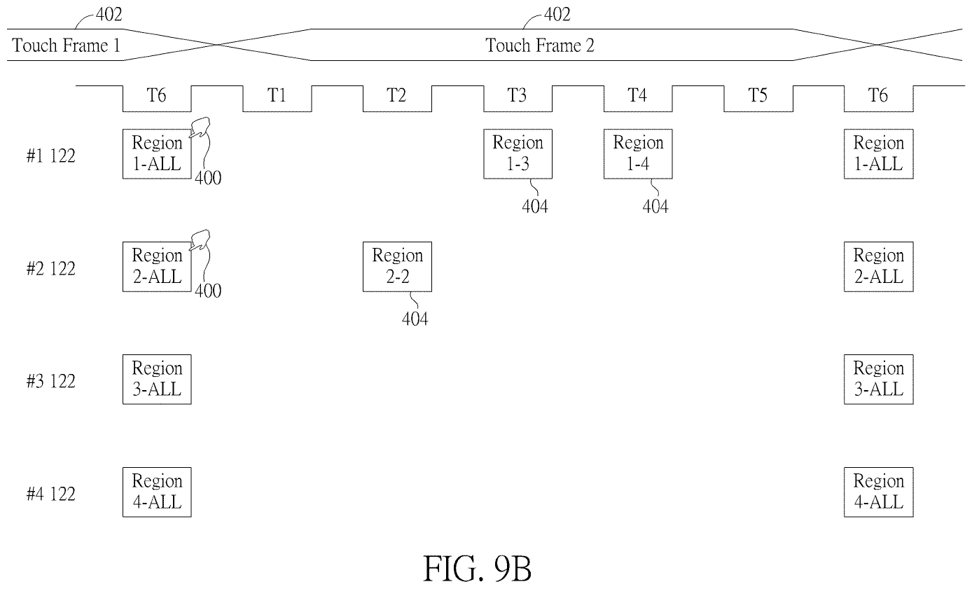

FIG. 9A depicts an alternative example of FIG. 7A when the touch event 400 includes two fingers concurrently pressing on the touch panel 300. One finger is pressed on Region 2-2, and the other finger is pressed on both Region 1-3 and Region 1-4. FIG. 9B describe how scanning during touch frame periods 402 are configured based on arrangements of FIG. 9A.

In FIG. 9B, similar to FIG. 7B, when the 20 zone signals from the coarse scan period of the first touch frame period 402 (e.g., T6 of Touch Frame 1) determined the touch event 400 to be associated with Region 1-3 and Region 1-4 of Column 1 and Region 2-2 of Column 2, the triggered zone 404 would be set as Region 1-3, Region 1-4, and Region 2-2. Therefore, the 5 fine scan periods of the second touch frame period 402 (e.g., T1 through T5 of Touch Frame 2) will see Region 2-2, Region 1-3, and Region 1-4 to be scanned respectively during the corresponding periods T2, T3 and T4 to generate the cell signals of the triggered zones 404. Moreover, the untriggered zones during the 5 fine scan periods would be set as all regions 320 of the touch panel 300 except Region 2-2, Region 1-3, and Region 1-4, and the untriggered zones would not be scanned to save power.

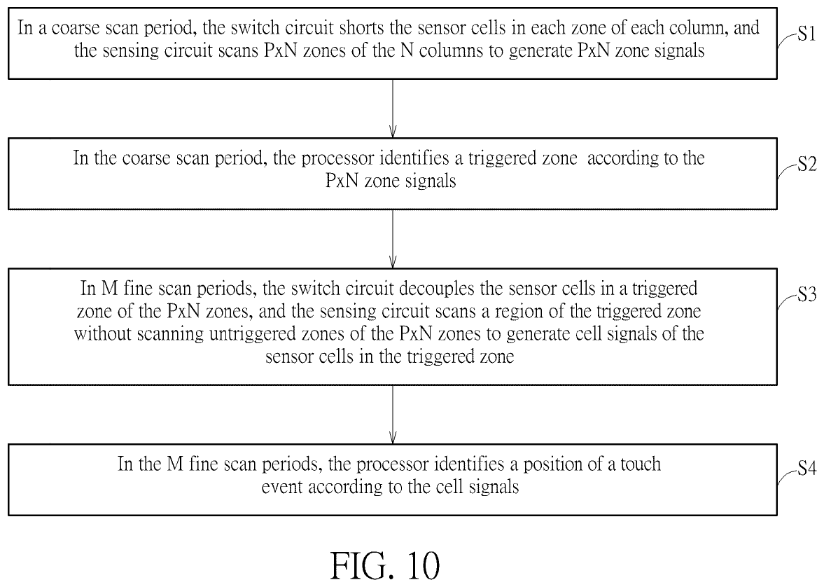

FIG. 10 is a schematic flow chart of a method for use in the touch controller 100 to control the touch panel 300. The method 400 includes Steps S1 to S4. Any reasonable step change or adjustment is within the scope of the present disclosure. Steps S1 to S4 are detailed as follows:
S1: in a coarse scan period, the switch circuit shorts the sensor cells in each zone of each column, and the sensing circuit scans P×N zones of the N columns to generate P×N zone signals;
S2: in the coarse scan period, the processor identifies a triggered zone according to the P×N zone signals;
S3: in M fine scan periods, the switch circuit decouples the sensor cells in a triggered zone of the P×N zones, and the sensing circuit scans a region of the triggered zone without scanning untriggered zones of the P×N zones to generate cell signals of the sensor cells in the triggered zone; and
S4: in the M fine scan periods, the processor identifies a position of a touch event according to the cell signals.

The touch controller and the method for use in the touch controller configures a rough scan period to identify a triggered zone on the touch panel and a fine scan period to finely scan the sensor cells of the triggered zone to identify an exact position of the touch event on the touch panel, without scanning the sensor cells of the untriggered zones on the touch panel. Therefore, power consumed by the electronic devices having the touch panel would only spend on sensor cells associated with the touch event, thus power efficiency for controlling a touch panel is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch controller for controlling a touch panel, the touch panel comprising an array of sensor cells divided into N columns, each column comprising M regions, the M regions in each column being grouped into P zones, N and M being integers exceeding 1, P being a positive integer less than M+1, the touch controller comprising:
a switch circuit coupled to the touch panel; and
a sensing circuit coupled to the switch circuit;
wherein:
in a coarse scan period, the switch circuit shorts the sensor cells in each zone of each column, and the sensing circuit scans P×N zones of the N columns to generate P×N zone signals; and
in M fine scan periods, the switch circuit decouples the sensor cells in a triggered zone of the P×N zones, and the sensing circuit scans a region of the triggered zone without scanning untriggered zones of the P×N zones to generate cell signals of the sensor cells in the triggered zone.

2. The touch controller of claim 1, wherein the coarse scan period and the M fine scan periods form a touch frame period.

3. The touch controller of claim 1, wherein:
P=1, the M regions in each column are grouped into 1 zone;
in the coarse scan period, the switch circuit shorts the sensor cells in each column, and the sensing circuit scans the N columns to generate N zone signals; and
in the M fine scan periods, the switch circuit decouples the sensor cells in M regions of a triggered zone of the N columns, and the sensing circuit scans the M regions of the triggered zone without scanning untriggered zones of the N columns to generate the cell signals of the sensor cells in the M regions of the triggered zone.

4. The touch controller of claim 3, wherein:
in an m-th period of the M fine scan periods, the sensing circuit scans an m-th region of the M regions of the triggered zone to generate the cell signals of the sensor cells in the m-th region of the M regions of the triggered zone, m being an integer ranging between 1 and M.

5. The touch controller of claim 3, wherein:
the sensing circuit is further coupled to a processor; and
in the coarse scan period, the processor identifies the triggered zone and the untriggered zones of the N columns according to the N zone signals.

6. The touch controller of claim 5, wherein:
in the coarse scan period, the processor further identifies another triggered zone of the N columns according to the N zones signals; and
in the M fine scan periods, the switch circuit further decouples the sensor cells in M regions of the another triggered zone of the N columns and the sensing circuit further scans the M regions of the another triggered zone of the N columns to generate the cell signals of the sensor cells in the M regions of the another triggered zone.

7. The touch controller of claim 6, wherein:
in an m-th period of the M fine scan periods, the sensing circuit scans an m-th region of the M regions of the triggered zone and an m-th region of the M regions of the another triggered zone to generate the cell signals of the sensor cells in the m-th region of the M regions of the triggered zone and the cell signals of the sensor cells in the m-th region of the M regions of the another triggered zone, m being an integer ranging between 1 and M.

8. The touch controller of claim 1, wherein:
P=M, each region in each column is grouped into 1 zone;
in the coarse scan period, the switch circuit shorts the sensor cells in each region of each column, and the sensing circuit scans M×N regions of the N columns to generate M×N zone signals; and
in the M fine scan periods, the switch circuit decouples the sensor cells in a triggered zone of the M×N regions without scanning untriggered zones of the M×N regions to generate the cell signals of the sensor cells in the triggered zone.

9. The touch controller of claim 8, wherein:
the triggered zone is in an m-th region of a column of the N columns, m being an integer ranging between 1 and M; and
in an m-th fine scan period of the M fine scan periods, the switch circuit decouples the sensor cells in the m-th region of the column of the N columns, and the sensing circuit scans the m-th region of the column of the N columns without scanning the untriggered zones of the M×N regions.

10. The touch controller of claim 8, wherein:
the sensing circuit is further coupled to a processor; and
in the coarse scan period, the processor identifies the triggered zone and the untriggered zones of the M×N regions according to the M×N zone signals.

11. The touch controller of claim 10, wherein in the M fine scan periods, the processor identifies a triggered cell in the triggered zone according to the cell signals.

12. The touch controller of claim 10, wherein:
in the coarse scan period, the processor further identifies another triggered zone of the M×N regions according to the M×N zone signals; and
in the M fine scan periods, the switch circuit further decouples the sensor cells in the another triggered zone of the M×N regions, and the sensing circuit further scans the another triggered zone of the M×N regions to generate the cell signals of the sensor cells in the another triggered zone.

13. The touch controller of claim 12, wherein:
the triggered zone and the another triggered zone are respectively an (m1)-th region and an (m2)-th region of a column of the N columns, m1 and m2 being different integers ranging between 1 and M;
in an (m1)-th fine scan period of the M fine scan periods, the switch circuit decouples the sensor cells in the (m1)-th region of the column of the N columns, and the sensing circuit scans the (m1)-th region of the column of the N columns without scanning the untriggered zones of the M×N regions to generate the cell signals of the sensor cells in the (m1)-th region of the column of the N columns; and
in an (m2)-th fine scan period of the M fine scan periods, the switch circuit decouples the sensor cells in the (m2)-th region of the column of the N columns, and the sensing circuit scans the (m2)-th region of the column of the N columns without scanning the untriggered zones of the M×N regions to generate the cell signals of the sensor cells in the (m2)-th region of the column of the N columns.

14. The touch controller of claim 12, wherein:
the triggered zone is an (m1)-th region of an (n1)-th column of the N columns, and the another triggered zone is an (m2)-th region of an (n2)-th column of the N columns, m1 and m2 being different integers ranging between 1 and M, n1 and n2 being different integers ranging between 1 and N;
in an (m1)-th fine scan period of the M fine scan periods, the switch circuit decouples the sensor cells in the (m1)-th region of the (n1)-th column of the N columns, and the sensing circuit scans the (m1)-th region of the (n1)-th column of the N columns without scanning the untriggered zones of the M×N regions to generate the cell signals of the sensor cells in the (m1)-th region of the (n1)-th column of the N columns; and
in an (m2)-th fine scan period of the M fine scan periods, the switch circuit decouples the sensor cells in the (m2)-th region of the (n2)-th column of the N columns, and the sensing circuit scans the (m2)-th region of the (n2)-th column of the N columns without scanning the untriggered zones of the M×N regions to generate the cell signals of the sensor cells in the (m2)-th region of the (n2)-th column of the N columns.

15. The touch controller of claim 12, wherein:
the triggered zone is an (m1)-th region of an (n1)-th column of the N columns, and the another triggered zone is an (m1)-th region of an (n2)-th column of the N columns, m1 being an integer ranging between 1 and M, n1 and n2 being different integers ranging between 1 and N; and
in an (m1)-th fine scan period of the M fine scan periods, the switch circuit decouples the sensor cells in the (m1)-th region of the (n1)-th column of the N columns and the sensor cells in the (m1)-th region of the (n2)-th column of the N columns, and the sensing circuit scans the (m1)-th region of the (n1)-th column of the N columns and the (m1)-th region of the (n2)-th column of the N columns without scanning the untriggered zones of the M×N regions to generate the cell signals of the sensor cells in the (m1)-th region of the (n1)-th column of the N columns and the cell signals of the sensor cells in the (m1)-th region of the (n2)-th column of the N columns.

16. A method for use in a touch controller to control a touch panel, the touch panel comprising an array of sensor cells divided into N columns, each column comprising M regions, the M regions in each column being grouped in to P zones, N and M being integers exceeding 1, P being a positive integer less than M+1, the touch controller comprising a switch circuit and a sensing circuit, the method comprising:
in a coarse scan period, the switch circuit shorting the sensor cells in each zone of each column, and the sensing circuit scanning P×N zones of the N columns to generate P×N zone signals; and
in M fine scan periods, the switch circuit decoupling the sensor cells in a triggered zone of the P×N zones, and the sensing circuit scanning a region of the triggered zone without scanning untriggered zones of the P×N zones to generate cell signals of the sensor cells in the triggered zone.

17. The method of claim 16, wherein the coarse scan period and the M fine scan periods form a touch frame period.

18. The method of claim 16, wherein:
P=1, the M regions in each column are grouped into 1 zone;
in the coarse scan period, the switch circuit shorting the sensor cells in each zone of each column, and the sensing circuit scanning the P×N zones of the N columns to generate the P×N zone signals comprises:
in the coarse scan period, the switch circuit shorting the sensor cells in each column, and the sensing circuit scanning the N columns to generate N zone signals; and
in the M fine scan periods, the switch circuit decoupling the sensor cells in the triggered zone of the P×N zones, and the sensing circuit scanning the region of the triggered zone without scanning the untriggered zones of the P×N zones to generate the cell signals of the sensor cells in the triggered zone comprises:
in the M fine scan periods, the switch circuit decoupling the sensor cells in M regions of a triggered zone of the N columns, and the sensing circuit scanning the M regions of the triggered zone without scanning untriggered zones of the N columns to generate the cell signals of the sensor cells in the M regions of the triggered zone.

19. The method of claim 18, wherein in the M fine scan periods, the switch circuit decoupling the sensor cells in M regions of the triggered zone of the N columns, and the sensing circuit scanning the M regions of the triggered zone without scanning the untriggered zones of the N columns to generate the cell signals of the sensor cells in the M regions of the triggered zone comprises:
in an m-th period of the M fine scan periods, the sensing circuit scanning an m-th region of the M regions of the triggered zone to generate the cell signals of the sensor cells in the m-th region of the M regions of the triggered zone, m being an integer ranging between 1 and M.

20. The method of claim 18, wherein the sensing circuit is coupled to a processor, and the method further comprises:
in the coarse scan period, the processor identifying the triggered zone and the untriggered zones of the N columns according to the N zone signals.

21. The method of claim 20, further comprises:
in the coarse scan period, the processor further identifying another triggered zone of the N columns according to the N zones signals; and
in the M fine scan periods, the switch circuit further decoupling the sensor cells in M regions of the another triggered zone of the N columns and the sensing circuit further scanning the another triggered zone of the N columns to generate the cell signals of the sensor cells in the M regions of the another triggered zone.

22. The method of claim 21, wherein:
in the M fine scan periods, the switch circuit decoupling the sensor cells in the M regions of a triggered zone of the N columns, and the sensing circuit scanning the M regions of the triggered zone without scanning the untriggered zones of the N columns to generate the cell signals of the sensor cells in the M regions of the triggered zone comprises:
in an m-th period of the M fine scan periods, the sensing circuit scanning an m-th region of the M regions of the triggered zone to generate the cell signals of the sensor cells in the m-th region of the M regions of the triggered zone, m being an integer ranging between 1 and M; and
in the M fine scan periods, the switch circuit further decoupling the sensor cells in the M regions of the another triggered zone of the N columns and the sensing circuit further scanning the M regions of the another triggered zone of the N columns to generate the cell signals of the sensor cells in the M regions of the another triggered zone comprises:
in the m-th period of the M fine scan periods, the sensing circuit scanning an m-th region of the M regions of the another triggered zone to generate the cell signals of the sensor cells in the m-th region of the M regions of the another triggered zone.

23. The method of claim 16, wherein:
P=M, each region in each column is grouped into 1 zone;
in the coarse scan period, the switch circuit shorting the sensor cells in each zone of each column, and the sensing circuit scanning the P×N zones of the N columns to generate the P×N zone signals comprises:
in the coarse scan period, the switch circuit shorting the sensor cells in each region of each column, and the sensing circuit scanning M×N regions of the N columns to generate M×N zone signals; and
in the M fine scan periods, the switch circuit decoupling the sensor cells in the triggered zone of the P×N zones, and the sensing circuit scanning the region of the triggered zone without scanning the untriggered zones of the P×N zones to generate the cell signals of the sensor cells in the triggered zone comprises:
in the M fine scan periods, the switch circuit decoupling the sensor cells in a triggered zone of the M×N regions without scanning untriggered zones of the M×N regions to generate the cell signals of the sensor cells in the triggered zone.

24. The method of claim 23, wherein:
the triggered zone is in an m-th region of a column of the N columns, m being an integer ranging between 1 and M; and
in the M fine scan periods, the switch circuit decoupling the sensor cells in the triggered zone of the M×N regions without scanning the untriggered zones of the M×N regions to generate the cell signals of the sensor cells in the triggered zone comprises:
in an m-th fine scan period of the M fine scan periods, the switch circuit decoupling the sensor cells in the m-th region of the column of the N columns, and the sensing circuit scanning the m-th region of the column of the N columns without scanning the untriggered zones of the M×N regions.

25. The method of claim 23, wherein the sensing circuit is further coupled to a processor, and the method further comprises:
in the coarse scan period, the processor identifying the triggered zone and the untriggered zones of the M×N regions according to the M×N zone signals.

26. The method of claim 25, further comprising:
in the M fine scan periods, the processing identifying a triggered cell in the triggered zone according to the cell signals.

27. The method of claim 25, further comprising:
in the coarse scan period, the processor identifying another triggered zone of the M×N regions according to the M×N zone signals; and
in the M fine scan periods, the switch circuit decoupling the sensor cells in the another triggered zone of the M×N regions, and the sensing circuit scanning the another triggered zone of the M×N regions to generate the cell signals of the sensor cells in the another triggered zone.

28. The method of claim 27, wherein:
the triggered zone and the another triggered zone are respectively an (m1)-th region and an (m2)-th region of a column of the N columns, m1 and m2 being different integers ranging between 1 and M;
in the M fine scan periods, the switch circuit decoupling the sensor cells in the triggered zone of the M×N regions, and the sensing circuit scanning the triggered zone of the M×N regions without scanning the untriggered zones of the M×N regions to generate the cell signals of the sensor cells in the triggered zone comprises:
in an (m1)-th fine scan period of the M fine scan periods, the switch circuit decoupling the sensor cells in the (m1)-th region of the column of the N columns, and the sensing circuit scanning the (m1)-th region of the column of N columns without scanning the untriggered zones of the M×N regions to generate the cell signals of the sensor cells in the (m1)-th region of the column of the N columns; and
in the M fine scan periods, the switch circuit decoupling the sensor cells in the another triggered zone of the M×N regions, and the sensing circuit scanning the another triggered zone of the M×N regions to generate the cell signals of the sensor cells in the another triggered zone comprises:
in an (m2)-th fine scan period of the M fine scan periods, the switch circuit decoupling the sensor cells in the (m2)-th region of the column of the N columns, and the sensing circuit scanning the (m2)-th region of the column of the N columns without scanning the untriggered zones of the M×N regions to generate the cell signals of the sensor cells in the (m2)-th region of the column of the N columns.

29. The method of claim 27, wherein:
the triggered zone is an (m1)-th region of an (n1)-th column of the N columns, and the another triggered zone is an (m2)-th region of an (n2)-th column of the N columns, m1 and m2 being different integers ranging between 1 and M, n1 and n2 being different integers ranging between 1 and N;
in the M fine scan periods, the switch circuit decoupling the sensor cells in the triggered zone of the M×N regions, and the sensing circuit scanning the triggered zone of the M×N regions without scanning the untriggered zones of the M×N regions to generate the cell signals of the sensor cells in the triggered zone comprises:
in an (m1)-th fine scan period of the M fine scan periods, the switch circuit decoupling the sensor cells in the (m1)-th region of the (n1)-th column of the N columns, and the sensing circuit scanning the (m1)-th region of the (n1)-th column of the N columns without scanning the untriggered zones of the M×N regions to generate the cell signals of the sensor cells in the (m1)-th region of the (n1)-th column of the N columns; and
in the M fine scan periods, the switch circuit decoupling the sensor cells in the another triggered zone of the M×N regions, and the sensing circuit scanning the another triggered zone of the M×N regions to generate the cell signals of the sensor cells in the another triggered zone comprises:
in an (m2)-th fine scan period of the M fine scan periods, the switch circuit decouples the sensor cells in the (m2)-th region of the (n2)-th column of the N columns, and the sensing circuit scans the (m2)-th region of the (n2)-th column of the N columns without scanning the untriggered zones of the M×N regions to generate the cell signals of the sensor cells in the (m2)-th region of the (n2)-th column of the N columns.

30. The method of claim 27, wherein:
the triggered zone is an (m1)-th region of an (n1)-th column of the N columns, and the another triggered zone is an (m1)-th region of an (n2)-th column of the N columns, m1 being an integer ranging between 1 and M, n1 and n2 being different integers ranging between 1 and N; and
in the M fine scan periods, the switch circuit decoupling the sensor cells in the triggered zone of the M×N regions, and the sensing circuit scanning the triggered zone of the M×N regions without scanning the untriggered zones of the M×N regions to generate the cell signals of the sensor cells in the triggered zone comprises:
in an (m1)-th fine scan period of the M fine scan periods, the switch circuit decoupling the sensor cells in the (m1)-th region of the (n1)-th column of the N columns, and the sensing circuit scanning the (m1)-th region of the (n1)-th column of the N columns without scanning the untriggered zones of the M×N regions to generate the cell signals of the sensor cells in the (m1)-th region of the (n1)-th column of the N columns; and
in the M fine scan periods, the switch circuit decoupling the sensor cells in the another triggered zone of the M×N regions, and the sensing circuit scanning the another triggered zone of the M×N regions to generate the cell signals of the sensor cells in the another triggered zone comprises:
in an (m1)-th fine scan period of the M fine scan periods, the switch circuit decoupling the sensor cells in the (m1)-th region of the (n2)-th column of the N columns, and the sensing circuit scanning the (m1)-th region of the (n2)-th column of the N columns without scanning the untriggered zones of the M×N regions to generate the cell signals of the sensor cells in the (m1)-th region of the (n2)-th column of the N columns.
